(19) United States
(12) Patent Application Publication
(10) Pub. No.: US 2025/0178933 A1
(43) Pub. Date: Jun. 5, 2025

(54) ELECTROCHEMICAL CARBON REMOVAL FROM WATER VIA CARBON MINERALIZATION

(71) Applicant: Cornell University, Ithaca, NY (US)

(72) Inventors: Greeshma GADIKOTA, Ithaca, NY (US); Peilong LU, Ithaca, NY (US)

(73) Assignee: Cornell University, Ithaca, NY (US)

(21) Appl. No.: 18/845,105

(22) PCT Filed: Mar. 10, 2023
(86) PCT No.: PCT/US2023/064107

§ 371 Date: Sep. 9, 2024

Related U.S. Application Data
(60) Provisional application No. 63/269,143, filed on Mar. 10, 2022.

(51) Int. Cl. C02F 1/461; B01D 53/32; C02F 1/30; C02F 1/46; C02F 1/467; C02F 101/10; C02F 103/08; C25B 1/18; C25B 1/20; C25B 1/55; C25B 11/03; C25B 11/049; C25B 11/052

(52) U.S. Cl. CPC C02F 1/4618; B01D 53/326; C02F 1/30; C02F 1/4602; C02F 1/46109; C02F 1/4676; C25B 1/18; C25B 1/20; C25B 1/55; C25B 11/03; C25B 11/049; C25B 11/052; B01D 2257/504; C02F 2001/46142; C02F 2001/46157; C02F 2001/4619; C02F 2101/10; C02F 2103/08; C02F 2201/4619; C02F 2305/10

(57) ABSTRACT

Provided are methods for recovering calcium carbonate (CaCO₃) and magnesium hydroxide (Mg(OH)₂) from an aqueous solution containing Ca²⁺ and Mg²⁺ ions. The method includes: introducing the aqueous solution into an electrochemical cell having a chamber with a photoactive cathode and an anode therein; and then performing process (a) and process (b). Process (a) entails introducing a source of (bi) carbonate anion into the cell, providing a voltage across the cell, resulting in a process (a) water reduction reaction at the cathode, and precipitating solid CaCO₃ from the solution, facilitated by hydroxide ions generated from the process (a) water reduction reaction. Process (b) entails providing a voltage across the cell, resulting in a process (b) water reduction reaction at the cathode, and precipitating solid Mg(OH)₂ from the solution, facilitated by hydroxide ions generated from the process (b) water reduction reaction.

### CROSS REFERENCE TO RELATED APPLICATIONS

This application claims priority to U.S. provisional application No. 63/269,143, filed on Mar. 10, 2022, the entire contents of which are hereby incorporated by reference herein.

### BACKGROUND

Greenhouse gases are gases that trap heat in the atmosphere. They have far-ranging deleterious environmental and health effects.

Nearly the entire increase in greenhouse gases to the current dangerous levels comes as a result of human activities.

It has been estimated that carbon dioxide (CO₂) accounts for 76% of global greenhouse gas emissions. AR5 Climate Change 2014: Mitigation of Climate Change. While the burning of fossil fuels (e.g., for heat, electricity, and transportation) is the primary source of CO2, other sources include deforestation, the burning of solid waste, and other industrial processes.

The ocean absorbs about 30% of the carbon dioxide that is released into the atmosphere. As levels of atmospheric carbon dioxide increase, the amount of carbon dioxide absorbed by the ocean also increases, resulting in ocean acidification.

Ocean acidification refers to the ongoing decrease in the pH of ocean water caused by uptake of carbon dioxide from the atmosphere. Ocean acidification carries dire consequences for the ocean ecosystem, sea life, and related commercial industries.

Carbon dioxide is naturally removed from the atmosphere when it is absorbed by plants as part of the biological carbon cycle. However, plants alone are incapable of removing the excessive levels of carbon dioxide present in the atmosphere.

Various art relates to water treatment and carbonate precipitation processes; however, none are able to adequately address the ongoing need for carbon dioxide abatement.

U.S. Pat. No. 4,115,219 employs a sodium carbonate (Na₂CO₃)/sodium hydroxide (NaOH) purification process wherein raw brine is sequentially contacted with sodium carbonate and sodium hydroxide for impurity precipitation before the processed brine is subsequently used in a mercury electrolytic cell to produce chlorine. Unlike the present invention, U.S. Pat. No. 4,115,219 relates to a chloralkali process, which is an industrial process for the electrolysis of sodium chloride (NaCl) solutions and is used to produce chlorine and sodium hydroxide (caustic soda). Generally, there are three chloralkali production methods in use: mercury cell, as described in U.S. Pat. No. 4,115,219, diaphragm cell, and membrane cell. The mercury cell method (which is also referred to as an amalgam process, as mercury is the cathode, where sodium is produced and forms an amalgam with the mercury) has largely been phased out due to the large amount of mercury used, which leads to serious environmental problems (mercury emitted accumulates in the environment; further, the chlorine and sodium hydroxide produced via the mercury-cell chloralkali process are themselves contaminated with trace amounts of mercury).

U.S. Pat. No. 11,465,925 relates to a method of capturing carbon from sea water. Reverse osmosis is performed on the sea water to produce fresh water and brine. The next step involves the creation of hydroxides via a cation exchange membrane electrolyzer cell process using the fresh water and brine. The cation exchange membrane electrolyzer has an anode chamber and a cathode chamber separated by a membrane. The brine is provided to the electrolyzer. A current is passed through the brine and fresh water, thereby producing a hydroxide solution in a cathode chamber of the electrolyzer. The hydroxide solution is collected and placed into a contacting chamber and new sea water introduced. Precipitates are produced comprising at least calcium carbonate and magnesium carbonate.

EP 0 995 719 A1 relates to a process for purifying sols comprising precipitating magnesium as magnesium hydroxide and calcium as calcium carbonate and removing from the sols. Similar to U.S. Pat. No. 4,115,219, and contrary to the present invention, the object of EP 0 995 719 A1 is to clean brine before it is used in a chloralkali (amalgam) process to make chlorine. An object is to remove cationic impurities-such as calcium, magnesium, and iron—from the brine before electrolysis in the cell, as such impurities are referred to as “electrolysis poisons”. The reference discloses that “Surprisingly, it was found that by adjusting the calcium magnesium ratio in a brine the cleaning of the brine is much more effective and is more economical to carry out.” Thus, in accordance with the reference, the ratio of calcium to magnesium in the brine before precipitation of magnesium and calcium is adjusted to 1-7:1.

U.S. Pat. No. 5,356,610 relates to a method for purifying various liquors produced or obtained in an alkali metal chlorate process, where substantial ion-exchange capacity and advanced filters can be replaced by precipitation and co-separation of chemical compounds. The method comprises adding carbonate ions and an iron-containing compound to the liquor for precipitating calcium carbonate and forming and precipitating a complex of iron ions and a silicon compound, and subsequently co-separating the precipitates from the thus purified liquor. Alkali metal chlorate is produced by electrolysis of an electrolyte containing alkali metal chloride. Impurities—such as calcium, magnesium, and fluoride ions and silicon compounds—cause depositions on the cathodes during electrolysis, which is detrimental. The reference thus aims to remove calcium ions and silicon compounds from chlorate electrolytes.

FR 2 142 731 A1 relates to a method for purifying an aqueous solution of crude sodium chloride. More particularly, the reference relates to an improvement in a process for purifying an aqueous solution of crude sodium chloride comprising mercury, and to a method for reducing the amount of mercury lost in a coprecipitate state.

WO 2009/006295 relates to desalination methods that include carbonate compound precipitation, whereby feed water is subjected to carbonate compound precipitation conditions prior to desalination. In the methods, a carbonate compound precipitation step is performed, such that feedwater and/or waste brine of the desalination process is subjected to carbonate compound precipitation conditions.

WO 2022/216741 relates to methods that convert waste products and low-value minerals into carbon dioxide (CO2)-neutral materials.

WO 2022/197954 relates to electrochemical systems and methods producing acid and base solutions, including for use in carbon capture. Disclosed methods entail producing an acid and a base with an electrochemical acid-base generator; dissolving a mineral in the acid to produce a mineral rich solution, separating silica from the mineral rich solution to form a silica depleted solution; adding a first portion of the base to the silica depleted solution to remove impurities by precipitation, adding a second portion of the base until ferrous hydroxide (Fe(OH)₂) precipitates, then pausing base addition and removing the ferrous hydroxide precipitate from the solution; then adding a third portion of the base to the iron-depleted solution to precipitate magnesium hydroxide (Mg(OH)₂) and/or calcium hydroxide (Ca(OH)₂); then recovering a salt solution and directing the recovered salt solution to the electrochemical acid-base generator to produce a new acid and a new base.

WO 2012/085552 relates to processing units and methods for desalination and greenhouse gas (GHG) sequestration. The processing units have an electrochemical separation cell in fluid communication with a separate cathodic reaction cell, and a separate anodic reaction cell. The separation cell comprises an ion-containing first aqueous solution. The cathodic reaction cell comprises a second aqueous solution including cathodic products of electrochemical separation of the first aqueous solution.

U.S. Pat. No. 9,493,368 relates to a method of precipitating scale from water that includes providing an electrochemical cell having a primary cathode chamber including a first electrode therein, a primary anode chamber including a second electrode therein, and a cation exchange membrane separating the primary cathode chamber from the primary anode chamber. A flow of feed water is split into separate input flows to each of the primary cathode chamber and the primary anode chamber. The pH of the water in the primary anode chamber is reduced by electrolysis. The pH of water in the primary cathode chamber is increased by electrolysis, and cations are removed from the water in the primary cathode chamber by forming scale on the first electrode in the primary cathode chamber. Separate treated water output flows, from each of the primary cathode chamber and primary anode chamber, are combined into a combined conditioned water flow.

U.S. Pat. No. 10,407,327 relates to a bioelectrochemical system capable of removing polyvalent ions from seawater. The bioelectrochemical system comprises: an anode chamber comprising an anode which accommodates an electron produced when treating an organic material in wastewater with a microorganism; a cathode chamber comprising a cathode receiving the electron from the anode, for producing a hydroxide ion by reacting the electron with oxygen and water provided from the outside, and depositing the polyvalent ion inside an electrolyte by using the hydroxide ion; and an anion exchange membrane for blocking the polyvalent ion inside the electrolyte from moving to the anode chamber. Electrochemically active bacteria are attached to the anode.

U.S. Pat. No. 11,413,578 relates to methods of removing carbon dioxide from an aqueous stream or gaseous stream by: contacting the gaseous stream comprising carbon dioxide, when present, with an aqueous solution comprising ions capable of forming an insoluble carbonate salt; contacting the aqueous solution comprising carbon dioxide with an electroactive mesh that induces its alkalinization thereby forcing the precipitation of a carbonate solid from the solution and thereby the removal of dissolved inorganic carbon by electrolysis; and removing the precipitated carbonate solids from the solution, or the surface of the mesh where they may deposit.

U.S. Pat. No. 4,839,003 relates to a process of producing alkali hydroxide, chlorine and hydrogen by the electrolysis of an aqueous alkali chloride solution in a membrane cell wherein a high-NaCl solid salt which contains impurities is dissolved in water in a salt dissolver, precipitating chemicals are added to the salt solution to precipitate the impurities, and the resulting mixture is fed to a thickener, from which precipitates and clarified raw brine are separately withdrawn, the raw brine is subjected to a fine purification, the finely purified brine is supplied to the membrane electrolytic cell, and spent brine is fed to the salt dissolver.

GB 822,990 relates to a process for the evaporation of aqueous solutions, including sea water, in which the formation of calcium carbonate and magnesium hydroxide containing scales is reduced or prevented by adjustment of the hydrogen ion concentration of the solution prior to or during evaporation. The process comprises adding to the solution hydrogen ions which have been generated in the anode compartment of an electric cell operating in conjunction with the evaporator from a solution containing a sufficient concentration of ions such as sulphate, nitrate, or phosphate ions to result in principally hydroxyl ions being discharged at the anode of the cell with the liberation of oxygen and/or in the promotion of an oxidation reaction at the anode with the consequent generation of hydrogen ions.

U.S. Pat. Nos. 8,333,944 and 7,887,694 relate to methods of sequestering carbon dioxide by precipitating a storage stable carbon dioxide sequestering product from an alkaline-earth-metal-containing water and then disposing of the product.

U.S. Pat. No. 9,302,216 relates to a carbon dioxide gas fixation method and apparatus, wherein seawater is electrolyzed, anodic electrolyzed water and cathodic electrolyzed water produced by electrolysis of the seawater are separated, alkaline material is inputted into the anodic electrolyzed water to adjust pH, carbon dioxide gas is blown into the cathodic electrolyzed water to fix the carbon dioxide gas as carbonate, and the anodic electrolyzed water after pH adjustment and the cathodic electrolyzed water after carbonate fixation are intermixed, and discharged in a state where a pH of the intermixed water is identical to a pH of the seawater.

U.S. Pat. No. 8,470,281 relates to a method of producing carbonate, comprising the steps of: providing a water-containing solution including cations that are precipitated in the form of a salt after undergoing a precipitation reaction with carbonate ions; and generating carbon dioxide microbubbles having a diameter of 50 μm or less in the water-containing solution to induce the precipitation reaction between the cations and the carbonate ions.

U.S. Pat. No. 4,336,232, similar to some of the art mentioned above, relates to the purification of salt brine, and in particular, to a process and apparatus wherein salt brine is treated to reduce the combined calcium-magnesium hardness of the brine to an acceptable level. The brine is preferably treated with sodium carbonate (soda ash) to convert the calcium ion to calcium carbonate and with caustic soda (sodium hydroxide) to convert the magnesium ion to magnesium hydroxide and the resultant flocculant is separated by filtration. Predetermined amounts of sodium carbonate and sodium hydroxide in excess of stoichiometric proportions are metered into the brine.

U.S. Pat. No. 5,409,680 relates to a process for removing alkaline earth metal impurities (e.g. calcium and magnesium ions) from an aqueous alkali metal chlorate solution which includes adding sufficient alkali metal carbonate or hydroxide or both to the impure solution to raise the pH to above 9 and form alkaline earth metal precipitates which are then removed from the pH-adjusted solution (e.g. by microfiltration).

Ho et al., Separation and Purification Technology 307 (2023), provides a review of mineral carbonation using seawater for carbon dioxide sequestration and utilization.

Díaz Nieto et al., Water Research 154 (2019) 117-124 relates to membrane electrolysis for the removal of Mg²⁺ and Ca²⁺ from lithium-rich brines.

Hasson et al., Desalination 230 (2008) 329-342, relates to electrochemical scale removal techniques for desalination applications.

Sharifian et al., Chemical Engineering Journal 438 (2022) 135326, relates to oceanic carbon capture through electrochemically induced in situ carbonate mineralization using a bipolar membrane.

None of the foregoing art provides for methods that lead to the precipitation of high purity Mg(OH)₂ and CaCO₃ as provided herein.

Conventional carbon mineralization, involving dissolution of Ca-/Mg-bearing solids and CO₂ in water, is heavily limited by the sluggish reactivity and the poor availability of homogeneous minerals. Several factors that affect the dissolution kinetics of alkaline minerals have been reported, including temperature, liquid to solid ratio, solvent, and particle size. Under normal temperature and pressure, this rate is too slow to be largely applied to industry, so it needs to be accelerated. Elevated temperature (>100° C.) or particular solvents (such as acids and amines) have been reported to mitigate this intrinsic sluggish kinetics. Besides, the heterogeneous nature of various alkaline resources is also another factor to consider when using these materials for traditional carbon mineralization.

Issues with mineral dissolution can be addressed by using Ca- and Mg-rich water as alkaline source, since the desired cations are already solubilized in the aqueous phase. Brine, a waste product of reverse osmosis desalination, is well known to be rich in Mg²⁺ and Ca²⁺, and considered as a potential resource for carbon mineralization. Brine is a type of high salinity water which can reach up to 70.000 ppm in total dissolved solids (TDS). At present, most seawater desalination plants directly discharge brine into the sea which has been identified as a risk for the marine ecosystem. Taking advantage of the brine for carbon mineralization can not only obviate the risk associated with saline water disposal, but also recover valuable elements such as magnesium and calcium. However, Ca²⁺ precipitation as carbonate is still limited by the scarcity of dissolved CO₂ in brine solutions. The thermodynamically unfavorable process of direct carbonation of atmospheric CO₂ with brine solutions still limits its application for carbon mineralization.

Coupling electrolysis with CO₂ mineralization enhances the carbonation of Ca and Mg ions from brine or hard water. The splitting of brine could produce OH⁻_{(aq)}, Cl_{2(g)} and H_{2(g)} during electrolysis. The in-situ generation of OH accelerates carbonate formation in aqueous solution, leading to an enhanced carbonation process. Several attributes of electrochemical CO₂ mineralization distinguish it from existing CO₂ capture and storage strategies. First, electrochemical mineralization occurs at the earth's surface, where it proceeds as an ex-site mineral storage process of CO₂ via carbonate formation. This is different from the traditional geological method in which CO₂ is required to be concentrated, compressed, and injected underground. Second, the process is not limited by varying reactivities and heterogeneities of feedstocks which affects dissolution. Conventional carbon storage heavily relies on the dissolution properties of alkaline resources. Over the past decades, several membrane electrolysis methods were proposed for mineralization and recovery of Ca²⁺ and Mg²⁺ from seawater or hard water. In principle, anion exchange membranes are used to separate cathodic and anodic compartments, and the generated hydroxyl in cathode controls the pH. Dissolving CO₂ in water becomes accelerated as pH increases. More recently, membrane-less electrolysis has been studied in order to simplify devices and cut down capital expenditures. Lalia and co-authors reported a Titania coated graphite cathode which was found to be effective for selective CaCO₃ precipitation as stable calcite polymorphs using brine, in the presence of CO₂, followed by selective Mg removal as brucite using pristine graphite cathode/anode. Lalia, B. S.; Khalil, A.; Hashaikeh, R., Selective Electrochemical Separation and Recovery of Calcium and Magnesium from Brine. Separation and Purification Technology 2021, 264, 118416. However, the complicated fabrication of Titania coated graphite cathode and cost involved with process modification for subsequent brucite precipitation makes it hard to scale up in industry.

Thus, a need remains for improved processes that contribute toward carbon dioxide abatement (including ocean carbon removal via electrochemical mineralization).

While certain aspects of conventional technologies have been discussed to facilitate disclosure of the invention, the Applicant in no way disclaims these technical aspects, and it is contemplated that the claimed invention may encompass one or more of the conventional technical aspects discussed herein.

In this application, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, embodiments of the present invention provide methods/processes that contribute toward carbon dioxide abatement via carbon mineralization, which is a process whereby carbon dioxide becomes a solid mineral, such as a carbonate. Embodiments also provide processes for producing magnesium hydroxide.

In a first aspect, the invention provides a method for recovering calcium carbonate (CaCO₃) and magnesium hydroxide (Mg(OH)₂) from an aqueous solution comprising calcium (Ca²⁺) and magnesium (Mg²⁺) ions, said method comprising:
introducing the aqueous solution into an electrochemical cell comprising a chamber that houses a photoactive cathode and an anode, wherein the cathode and anode are not separated by a membrane; and then
performing process (a):
   introducing a gaseous source of (bi) carbonate anion into the cell;
   providing a voltage across the cell, thereby resulting in a process (a) water reduction reaction at the cathode; and
   precipitating solid CaCO₃ from the solution, facilitated by hydroxide ions generated from the process (a) water reduction reaction;
and, separate from performing process (a), in the same chamber, performing process (b):
   providing a voltage across the cell, thereby resulting in a process (b)
   water reduction reaction at the cathode; and
      precipitating solid Mg(OH)₂ from the solution, facilitated by hydroxide ions generated from the process (b) water reduction reaction.

These and other objects, features, and advantages of this invention will become apparent from the following detailed description of the various aspects of the invention taken in conjunction with the accompanying drawings.

### BRIEF DESCRIPTION OF THE DRAWINGS

FIGS. 1A and 1B depict embodiments of process (a) and process (b), respectively.

FIG. 2 shows, in part a, concentrations of Mg²⁺ and Ca²⁺ in aqueous solution vary with pH. As pH rises, the concentrations start dropping as precipitation begins. Part b shows carbon speciation in a closed system. The concentrations of H₂CO₃_{_{(aq)}}*, HCO₃_{_{(aq)}}⁻, and CO₃_{_{(aq)}}²⁻ are a function of pH, which is calculated based on the ambient atmosphere with CO₂ partial pressure of 1 atm.

FIG. 3 shows, in part a, a schematic illustration of an embodiment of a two-mode (in this case, Mode 1 corresponds to process (b), and Mode 2 corresponds to process (a)) electrochemical mineralization. The two modes can be switched by supplying CO₂ to the cell or not. Part b is an XRD pattern of Ti mesh (inset: photography of a Ti mesh electrode used in experiments).

FIG. 4 shows ICP-OEM results of Ca and Mg in brine, and corresponding recovery efficiencies. Part a shows results obtained after process (b) electrolysis. Part b shows results obtained after process (b) and process (a) electrolysis. Note that in part b, each electrolysis was applied to both process (b) and process (a). Thus, the concentrations of Mg²⁺ in part b is almost the same as those in part a.

FIG. 5 shows ICP-OEM results and corresponding recovery efficiencies. Part a shows results obtained after electrolysis with CO₂ (i.e., process (a)) in various time-length operation. Part b shows results obtained after additional electrolysis with no CO₂ (i.e., process (b)). Note that in part b, each time length of electrolysis was applied to both processes.

FIG. 6 shows ICP-OEM results of 20-electrolysis for each of process (a) and process (b). −3 V vs. Ag/AgCl was applied in process (b).

FIG. 7 shows XRD patterns and FTIR spectra of the precipitates. The depicted Mode 1 corresponds to process (b), and the depicted Mode 2 corresponds to process (a). Depicted are: XRD patterns of the precipitates from (part a) Mode 1 and (part b) Mode 2 with 20-hour operation; and FTIR spectra of the precipitates from (part c) Mode 1 and (part d) Mode 2 with 20-hour electrolysis.

FIG. 8 shows TGA curves of precipitates from (part a) Mode 1 (process (b)) and (part b) Mode 2 (process (a)) with 20-hour operation.

FIG. 9 shows, from testing in Mode 1 (process (b)), (part a) SEM image, (part b) magnified image (square region), as well as corresponding EDS mapping involving (part c) Mg, (part d) Ca and (part e) EDS spectrum of the precipitate; and, from testing in Mode 2 (process (a)), (part f) SEM image (inset: magnified image from square area), (part g) magnified image (square region), as well as corresponding EDS mapping involving (part h) Mg, (part i) Ca and (part j) EDS spectrum of the precipitate.

FIG. 10 shows LSV curves obtained (part a) in the CO₂-free electrolyte and (part b) in the CO₂-saturated electrolyte (inset: magnified curve of TiO₂ mesh).

### DETAILED DESCRIPTION

In the following description, reference is made to the accompanying drawings and text that form a part hereof, and in which is shown by way of illustration specific embodiments which may be practiced. These embodiments are described in detail to enable those skilled in the art to practice the invention, and it is to be understood that other embodiments may be utilized and that structural, logical, and electrical changes may be made without departing from the scope of the present invention. The following and descriptions of example embodiments are, therefore, not to be taken in a limited sense, and the scope of the present invention is defined by the appended claims.

The present invention provides embodiments of methods for electrochemically enabled carbon removal via mineralization of aqueous solutions comprising calcium (Ca²⁺) and magnesium (Mg²⁺) ions. According to embodiments of the invention, Ca and Mg can be selectively recovered by a single cell electrolysis process without any cell modifications.

Carbon mineralization is a thermodynamically downhill process which could enable industries to be negative carbon emissions. Coupling electrochemical strategy with carbon mineralization (e.g., via seawater) can both obviate the problem of desalination, and also facilitate recovery of value-added elements such as magnesium. Further, with sluggish reactivities under ambient conditions, and poor homogenous mineral availability still limiting conventional carbon mineralization, embodiments of the present invention utilize an electrochemical method for carbon mineralization by using magnesium- and calcium-rich water such as brine, which is effective under ambient conditions. Embodiments utilize a two-mode electrolysis strategy that enables selective magnesium and calcium precipitation to generate brucite and calcite/aragonite, respectively. Carbon dioxide can be captured and stored in the form of carbonate during electrolysis. Compared with conventional carbon mineralization, embodiments of the present invention overcome the problems of mineral dissolution and limited availability of homogenous feedstock. Further, for conventional pathways, there are thermodynamic penalties resulting from CO₂ capture from air or flue gas and subsequent CO₂ release from solid or liquid substrates. In the sorption-desorption process, the energy expenditure is indispensable to overcome the decrease in entropy of CO₂ sorption and the increase in enthalpy of CO₂ desorption. In contrast, carbon mineralization, as provided by embodiments of the present invention, is a thermodynamically favorable process.

In a first aspect, the invention provides a method for recovering calcium carbonate (CaCO₃) and magnesium hydroxide (Mg(OH)₂) from an aqueous solution comprising calcium (Ca²⁺) and magnesium (Mg²⁺) ions, said method comprising:
introducing the aqueous solution into an electrochemical cell comprising a chamber that houses a photoactive cathode and an anode, wherein the cathode and anode are not separated by a membrane; and then
performing process (a):
   introducing a gaseous source of (bi) carbonate anion into the cell;
   providing a voltage across the cell, thereby resulting in a process (a) water reduction reaction at the cathode; and
   precipitating solid CaCO₃ from the solution, facilitated by hydroxide ions generated from the process (a) water reduction reaction;
and, separate from performing process (a), in the same chamber, performing process (b):
   providing a voltage across the cell, thereby resulting in a process (b) water reduction reaction at the cathode; and
   precipitating solid Mg(OH)₂ from the solution, facilitated by hydroxide ions generated from the process (b) water reduction reaction.

Process (a) and process (b) can be considered as two modes of the inventive method. However, as discussed herein, various embodiments contemplate that process (a) is mode 1 (i.e., the first-performed mode), whereas other embodiments contemplate that process (b) is mode 1.

In some embodiments, process (a) is performed before process (b).

In other embodiments, process (b) is performed before process (a).

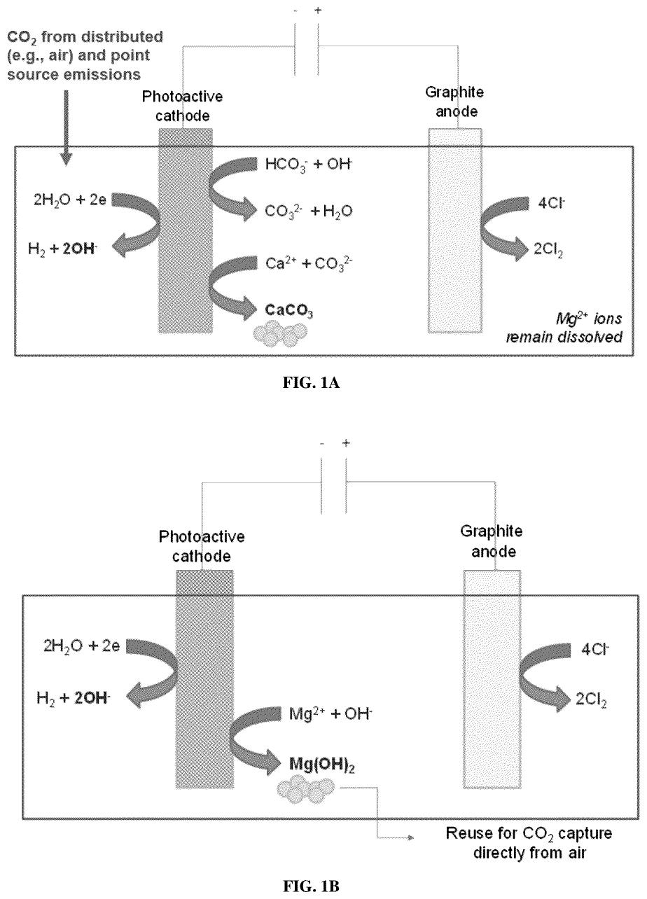

Process (a) removes CO₂ from the aqueous solution. Following process (a), the aqueous solution becomes Ca²⁺-depleted via the formation of the CaCO₃ precipitate. An embodiment of process (a) is depicted in FIG. 1A.

Process (b) removes Mg²⁺ from the aqueous solution. Following process (b), the aqueous solution becomes Mg²⁺-depleted via the formation of the Mg(OH)₂ precipitate. An embodiment of process (b) is depicted in FIG. 1B. While FIGS. 1A and B depict a graphite anode, any art-accepted material may be used for the anode.

Embodiments of the inventive method harness the differences in the solvation behavior of Mg²⁺ and Ca²⁺ ions. For example, Mg²⁺ ions have a stronger hydration shell compared to Ca²⁺ ions. As a result, the formation of Mg(OH)₂ is highly favored. However, in the presence of carbonate ions (present in process (a) from the gaseous source of (bi) carbonate anion), Ca²⁺ ions have a higher affinity to bind to the carbonate ions compared to Mg²⁺ ions since Ca²⁺ ions have a hydration shell that can be more easily disrupted compared to that of Mg²⁺ ions. As a result, calcium carbonate is favored in the presence of CO₂ and carbonate ions in process (a).

In process (a), a gaseous source of (bi) carbonate anion (e.g., CO₂ supply) is introduced into the cell, unlike in process (b) (thus, in embodiments of the invention, process (b) does not comprises introducing a source of (bi) carbonate anion into the cell). The hydroxide ions generated from water reduction facilitate the formation of calcium carbonate in the presence of CO₂ in process (a) and the formation of magnesium hydroxide in the absence of CO₂ in process (b).

Where process (a) is performed before process (b), process (a) is performed on aqueous solution comprising calcium (Ca²⁺) and magnesium (Mg²⁺) ions. Process (a) results in depleting Ca²⁺ ions from the aqueous solution, then process (b) is performed on the Ca²⁺ ion-depleted aqueous solution from process (a).

Where process (b) is performed before process (a), process (b) is performed on aqueous solution comprising calcium (Ca²⁺) and magnesium (Mg²⁺) ions. Process (b) results in depleting Mg²⁺ ions from the aqueous solution, then process (a) is performed on the Mg²⁺ ion-depleted aqueous solution from process (a). Performing process (b) before process (a) has the advantage of yielding higher purity Mg(OH)₂.

The aqueous solution may be any aqueous solution comprising Ca²⁺ and Mg²⁺ ions. In some embodiments, the aqueous solution comprises sea water or process water from an industrial process (e.g., brine).

In some embodiments, the concentration of Ca²⁺ ions in the aqueous solution treated in process (a) and/or process (b) is from 100 mg/L to 1500 mg/L (for example, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, or 1500 mg/L), including any and all ranges and subranges therein (e.g., 300 mg/L to 1500 mg/L, 400 mg/L to 1500 mg/L, 400 mg/L to 1400 mg/L, etc.).

In some embodiments, the concentration of Ca²⁺ ions in the aqueous solution treated in process (a) and/or process (b) is greater than or equal to 300 mg/L (e.g., greater than or equal to 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, or 850 mg/L).

In some embodiments, the concentration of Mg²⁺ ions in the aqueous solution treated in process (a) and/or process (b) is from 100 mg/L to 1500 mg/L (for example, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, or 1500 mg/L), including any and all ranges and subranges therein (e.g., 300 mg/L to 1500 mg/L, 400 mg/L to 1500 mg/L, 400 mg/L to 1400 mg/L, etc.).

In some embodiments, the concentration of Mg²⁺ ions in the aqueous solution treated in process (a) and/or process (b) is greater than or equal to 300 mg/L (e.g., greater than or equal to 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, or 1200 mg/L).

In some embodiments, for process (a) and/or process (b), the aqueous solution has a Ca²⁺ ion concentration and/or a Mg²⁺ ion concentration such that solubility limit(s) for producing solid carbonate and/or solid hydroxide are not reached under ambient conditions.

In some embodiments, the aqueous solution treated in process (a) and/or process (b) has a concentration of Ca²⁺ and/or Mg²⁺ ions of from 0 to 100,000 ppm (for example, 0, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, or 100000 ppm), including any and all ranges and subranges therein. As will be readily appreciated by a person having ordinary skill in the art, the initial concentrations of Ca²⁺ and Mg²⁺ ions in the aqueous solution prior to process (a) and process (b) will be higher than the concentrations after performing process (a) and process (b). If process (a) is performed first, then the solution treated in process (b) will be calcium depleted due to CaCO₃ precipitation during process (a). On the other hand, if process (b) is performed first, then the solution treated in process (a) will be magnesium depleted due to Mg(OH)₂ precipitation during process (b).

In some embodiments, performing process (a) results in a reduction in the concentration of Ca²⁺ ions in the aqueous solution corresponding to a removal efficiency of at least 60% (e.g., at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98%), based on the starting concentration of Ca²⁺ ions in the solution before performing process (a).

In some embodiments, performing process (b) results in a reduction in the concentration of Mg²⁺ ions in the aqueous solution corresponding to a removal efficiency of at least 60% (e.g., at least 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98%), based on the starting concentration of Mg²⁺ ions in the solution before performing process (b).

In some embodiments, process (a) is performed continuously for 1 to 48 hours (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, or 48 hours), including any and all ranges and subranges therein (e.g., 1-20 hours).

In some embodiments, process (b) is performed continuously for 1 to 48 hours (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, or 48 hours), including any and all ranges and subranges therein (e.g., 1-20 hours).

In some embodiments, the invention comprises performing process (a) independently of process (b), or comprises performing process (b) independently of process (a). At a minimum, for such embodiments, where process (a) is performed, the aqueous solution introduced into the cell comprises Ca²⁺ ions (e.g., in concentrations mentioned herein) and where process (b) is performed, the aqueous solution introduced into the cell comprises Mg²⁺ ions (e.g., in concentrations mentioned herein).

In some embodiments, the inventive method comprises, while performing process (a) and/or process (b), providing a voltage (e.g., that results in water oxidation) which is within the range of −4.5 V to −2.0 V across the cell (e.g., −4.5, −4.4, −4.3, −4.2, −4.1, −4.0, −3.9, −3.8, −3.7, −3.6, −3.5, −3.4, −3.3, −3.2, −3.1, −3.0, −2.9, −2.8, −2.7, −2.6, −2.5, −2.4, −2.3, −2.2, −2.1, or −2.0 V), including any and all ranges and subranges therein (e.g., −3.5 V to −2.0 V).

In some embodiments, during process (a), providing a voltage across the cell comprises pulsing the voltage by switching between higher and lower voltages.

In some embodiments, during process (b), providing a voltage across the cell comprises pulsing the voltage by switching between higher and lower voltages.

In some embodiments, the inventive method comprises performing process (a), thereby yielding a precipitated reaction product comprising the solid CaCO₃, wherein the precipitated reaction product from process (a):
comprises greater than or equal to 80 wt % CaCO₃ (e.g., greater than or equal to 80, 81, 82, 83, 84, 85, 86, 87, 88, 89, 90, 91, 92, 93, 94, 95, 96, 97, 98, or 99 wt % CaCO₃); and/or
comprises greater than or equal to 80 wt % CaCO₃ in calcite polymorph (e.g., greater than or equal to 80, 81, 82, 83, 84, 85, 86, 87, 88, 89, 90, 91, 92, 93, 94, 95, 96, 97, 98, or 99 wt % CaCO₃ calcite), optionally with any remaining CaCO₃ (e.g., at least 99%, 98%, or 97% remaining CaCO₃) being present in aragonite form; and/or
comprises less than or equal to 10 wt % Mg(OH)₂ (e.g., less than or equal to 10, 9, 8, 7, 6, 5, 4, 3, 2, 1, or 0.5 wt % Mg(OH)₂); and/or
is characterized by an infrared (IR) spectrum that does not show a peak corresponding to Mg(OH)₂.

In some embodiments, the inventive method comprises performing process (a), thereby precipitating the solid CaCO₃, wherein at least 80 wt % of the solid CaCO₃ (e.g., at least 80, 81, 82, 83, 84, 85, 86, 87, 88, 89, 90, 91, 92, 93, 94, 95, 96, 97, 98, or 99 wt %) is calcite.

In some embodiments, the inventive method comprises performing process (a), thereby precipitating the solid CaCO₃, wherein less than 20 wt % of the solid CaCO₃ (e.g., less than 20, 19, 18, 17, 16, 15, 14, 13, 12, 11, 10, 9, 8, 7, 6, 5, 4, 3, 2, or 1 wt %) is aragonite, and/or vaterite, and/or a combination thereof.

In some embodiments, the inventive method comprises performing process (b), thereby yielding a precipitated reaction product comprising the solid Mg(OH)₂, wherein the precipitated reaction product from process (b):
comprises greater than or equal to 80 wt % Mg(OH)₂ (e.g., greater than or equal to 80, 81, 82, 83, 84, 85, 86, 87, 88, 89, 90, 91, 92, 93, 94, 95, 96, 97, 98, or 99 wt % Mg(OH)₂); and/or
has a Mg(OH)₂ purity of greater than or equal to 80 wt % (e.g., greater than or equal to 80, 81, 82, 83, 84, 85, 86, 87, 88, 89, 90, 91, 92, 93, 94, 95, 96, 97, 98, or 99 wt % purity); and/or
comprises greater than or equal to 80 wt % Mg(OH)₂ in brucite crystalline form (e.g., greater than or equal to 80, 81, 82, 83, 84, 85, 86, 87, 88, 89, 90, 91, 92, 93, 94, 95, 96, 97, 98, or 99 wt % Mg(OH)₂ in brucite crystalline form); and/or
is powder having a surface area of 110-160 m² g⁻¹ (e.g., 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, or 160 m² g⁻¹), including any and all ranges and subranges therein (e.g., 135-155 m³ g⁻¹); and/or
comprises less than or equal to 10 wt % CaCO₃ (e.g., less than or equal to 10, 9, 8, 7, 6, 5, 4, 3, 2, 1, 0.5, or 0.1 wt % CaCO₃); and/or
is characterized by an infrared (IR) spectrum that does not show a peak corresponding to CaCO₃.

In some embodiments, the gaseous source of (bi) carbonate anion is a source of bicarbonate anion (e.g., gaseous CO₂, air, flue gas, etc.).

In some embodiments, the gaseous source of (bi) carbonate anion comes directly from air and/or point source emissions and/or post combustion CO₂ capture.

In some embodiments, the gaseous source of (bi) carbonate anion is a source of carbonate anion.

In some embodiments, the gaseous source of (bi) carbonate anion is a gaseous carrier (e.g., air, flue gas, etc.), having a CO₂ concentration in the range of 400 ppm to 1,000,000 ppm (wherein 1,000,000 ppm represents pure CO₂) (for example, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, 100000, 200000, 300000, 400000, 500000, 600000, 700000, 800000, 900000, or 1000000 ppm), including any and all ranges and subranges therein.

In some embodiments, the source of (bi) carbonate anion is a gaseous carrier (e.g., air, flue gas, etc.), comprising 0.04 volume % (vo. %) to 100 vol % CO₂ (e.g., 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 vol % CO₂), including any and all ranges and subranges therein.

In some embodiments, the source of (bi) carbonate anion is introduced into the cell via a pressurized gaseous stream.

In some embodiments, process (a) and/or process (b) does not comprise introducing any solid material into the aqueous solution. In some embodiments, the inventive method does not comprise introducing any solid material into the aqueous solution.

In some embodiments, process (a) and/or process (b) does not comprise introducing alkaline material into the aqueous solution.

In some embodiments, process (a) and/or process (b) does not comprise producing NaOH or HCl.

In some embodiments, process (a) and process (b) are performed without adjusting the ratio of Mg and Ca in the aqueous solution, apart from reduction caused via Mg- and Ca-depletion due to precipitation.

In some embodiments, process (a) and/or process (b) does not comprise adding iron or an iron-containing compound to the aqueous solution.

In some embodiments, the aqueous solution treated in process (a) and/or process (b) does not comprise solids. In some embodiments, the aqueous solution treated in process (a) and/or process (b) comprises less than 1 wt % solids (e.g., less than 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01 wt %).

In some embodiments, both solid CaCO₃ precipitate and solid Mg(OH)₂ precipitate are collected from the chamber simultaneously.

In some embodiments, solid CaCO₃ precipitate and solid Mg(OH)₂ precipitate are collected from the chamber separately.

In some embodiments, process (a) and process (b) are performed (starting with either process), continuously, without removing aqueous solution from the chamber between performing the two processes.

In some embodiments, performing process (a) and/or performing process (b) comprises stirring (e.g., via use of one or more stirring elements) the aqueous solution in the chamber (e.g., while apply a voltage across the cell).

In various embodiments, the photoactive cathode used in the inventive method is made from/comprises photoactive materials that facilitate the splitting of water into hydroxide species. Persons having ordinary skill in the art are readily able to identify and select such materials. Photoactive materials are described, for example, in Eftekhari A, Babu V J, Ramakrishna S (2017) Photoelectrode nanomaterials for photoelectrochemical water splitting. Int J Hydrog Energy 42:11078-11109, Yao B, Zhang J, Fan X, He J, Li Y. Surface Engineering of Nanomaterials for Photo-Electrochemical Water Splitting. Small. 2019 January; 15 (1) p. 1803746, Li D, Shi J, Li C. Transition-Metal-Based Electrocatalysts as Cocatalysts for Photoelectrochemical Water Splitting: A Mini Review. Small. 2018 June; 14 (23) p. 1704179, and Ji L, Lv C, Chen Z, Huang Z, Zhang C. Nickel-Based (Photo) Electrocatalysts for Hydrogen Production. Adv Mater. 2018 April; 30 (17) p. 1705653.

In some embodiments, the photoactive cathode comprises a metal, mixed metal composition, or (mixed) metal oxide. Examples of cathode materials include, but are not limited to, materials comprising titanium (including, e.g., titanium dioxide, TiO₂), copper, or steel, or functionalized and/or synthetic photoactive materials, e.g., comprising titanium copper, or steel. In some embodiments, the cathode comprises a metal. In some embodiments, the cathode comprises titanium, tungsten, carbon, copper, steel, nickel, platinum, palladium, iron, iridium, molybdenum, cobalt, gold, or silver. In some embodiments, the cathode comprises titanium, carbon, copper, or steel. In some embodiments, the cathode comprises an oxide coating (e.g., a metal oxide coating, such as molybdenum disulfide-zinc oxide, including a metal oxide of the metals discussed herein, e.g., NiO). In particular embodiments, the cathode comprises titanium mesh (e.g., TiO₂ mesh).

In some embodiments, industrial titanium mesh (e.g., TiO₂ mesh) is employed as electrode for efficient CO₂ mineralization, and selective recovery of valuable metals in the forms of Mg(OH)₂ and CaCO₃.

In some embodiments, the cathode comprises a texturized surface, such as, for example, a mesh surface, a porous surface, an etched surface, or a surface comprising nanostructures (e.g., structures having dimensions of 2 nm to 1000 nm, e.g., 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 nm, including any and all ranges and subranges therein).

The anode may be of an art-accepted material. In some embodiments, the anode comprises metal, a mixed metal composition, or a (mixed) metal oxide composition. In some embodiments, the anode comprises carbon (e.g., graphite). In some embodiments, the anode comprises nickel, platinum, palladium, iron, iridium, molybdenum, cobalt, gold, or silver.

Certain embodiments of the inventive method provide a simplified electrochemical strategy for carbon mineralization which occurs in a single-chamber cell.

In some embodiments where process (b) is performed before process (a), the generation of OH by electrolysis enhances the alkalinity of the aqueous solution (see Eq. 1 in Table I, below). As the pH rises, Mg²⁺ ions are thermodynamically preferential to precipitate as Mg(OH)₂ due to a significantly lower solubility product constant (Kₛₚ) (see Eqs. 2 & 3 in Table D). Here, the Kₛₚ equals the product of the aqueous activities of Mg²⁺ and OH at equilibrium, so it is also known as the equilibrium constant. Subsequent to performing process (b), process (a) is performed, and CO₂ is bubbled through the Ca-rich electrolyte (which is Mg-depleted from process (b)). Given that most of Mg has already been removed in process (b), the continuously generated OH ions helps accelerate CO₂ dissolution and favors the formation of carbonate (CO₃²⁻) over bicarbonate ions (H₂CO₃*) (see Eqs. 4-6 in Table I). Finally, the generated CO₃²⁻ ions react with calcium to produce insoluble calcium carbonate. (see Eqs. 7 & 8 in Table I).

TABLE I

| | | Eq. |
|---|---|---|
| 2H₂O_{(aq)} + 2e⁻ → 2OH⁻_{(aq)} + H₂^{_{(g)}} | E⁰ = 0.41 V, pH = 7 | (1) |
| Mg²⁺_{(aq)} + 2OH⁻_{(aq)} [symbol] Mg(OH)₂^{₍ₛ₎} | Kₛₚ = 5.61 × 10⁻¹² | (2) |
| Ca²⁺_{(aq)} + 2OH⁻_{(aq)} [symbol] Ca(OH)₂^{₍ₛ₎} | Kₛₚ = 5.02 × 10⁻⁶ | (3) |
| CO₂^{_{(g)}} + H₂O^{₍₁₎} [symbol] H₂CO₃*^{_{(aq)}} | Kₕ = 3.4 × 10⁻² | (4) |
| H₂CO₃*^{_{(aq)}} [symbol] [symbol] + H⁺_{(aq)} | Kₐ₁ = 4.47 × 10⁻⁷ | (5) |
| [symbol] [symbol] [symbol] + H⁺_{(aq)} | Kₐ₂ = 4.68 × 10⁻¹¹ | (6) |
| Ca²⁺_{(aq)} + [symbol] [symbol] CaCO₃^{₍ₛ₎} | Kₛₚ = 3.3 × 10⁻⁹ | (7) |
| Mg²⁺_{(aq)} + [symbol] [symbol] MgCO₃^{₍ₛ₎} | Kₛₚ = 1.6 × 10⁻³ | (8) |

Note:
H₂CO₃* represents the total CO₂ (aq) and H₂CO₃.

### EXAMPLES

The invention will now be illustrated, but not limited, by reference to the specific embodiments described in the following examples.

### Materials and Methods

Chemicals: Sodium chloride (NaCl, ≥99%, Sigma-Aldrich), Magnesium chloride (MgCl₂, 99%, Alfa Aesar), Calcium chloride dihydrate (CaCl₂·2H₂O, ˜99%, MP) were used without further purification. Besides, Magnesium hydroxide (Mg(OH)₂, ≥95%, Fisher chemical), Calcium hydroxide (Ca(OH)₂, ≥98%, Fisher chemical), Magnesium carbonate (Approx. 4MgCO₃·Mg(OH)₂·5H₂O, assay (MgO): 40.0-43.5%, Spectrum) and Calcium carbonate (CaCO₃, Lab grade, Ward's science) were used as standard chemicals. Deionized water (18.2 MΩ·cm, Millipore) was used in throughout the experiments.

Preparation of solution: Ca²⁺ and Mg²⁺ are the most abundant divalent cations in natural waters and often industrial waters such as brines and produced waters. Meanwhile, Cl⁻ anions usually offer charges compensation to the cations in these systems. In this study. 10 g NaCl, 2.21 g CaCl₂·2H₂O and 2.04 g MgCl₂ were dissolved in 200 mL deionized water, given 3000 mg/L of Ca²⁺ and 2600 mg/L of Mg²⁺ respectively. The pH was measured to be 8.42, while it decreased to 4.41 with CO₂ saturated.

Electrochemical measurements: All electrochemical measurements were performed with a potentiostat (Interface 1010E, Gamry instruments). Electrolysis was carried out in a 3-electrode system. Working electrode (cathode) was a piece of titanium mesh with an area of 1×1 cm² (with aperture of 0.8×1.5 mm and thickness of 0.1 mm). The reference and counter (anode) electrodes were Ag/AgCl electrode and platinum wire, respectively. The prepared artificial brine was used as the electrolyte (60 mL), and the applied potentials were controlled at −2.5 V vs. Ag/AgCl (all potentials in this work are in reference to Ag/AgCl unless otherwise specified).

Characterization of products: All precipitates collected after reactions were centrifuged and washed with deionized water, followed by drying at 80° C. The structural features are examined using X-ray diffraction (XRD. Bruker D8 Advance ECO powder diffractometer) with a voltage of 40 V and a current of 25 A. Obtained data was analyzed by Jade software, and crystalline species are identified via the International Centre for Diffraction (ICCD) database. Key functional groups are determined using attenuated total reflection-Fourier-transform infrared spectroscopy (ATR-FTIR, Thermo Fisher Nicolet iS50). The volatile components are determined using Thermogravimetric Analysis (TGA, TA Instruments, SDT 650). During TGA measurements, it is ramped from room temperature to 1000° C. with a rate of 10° C. under Na atmosphere. The morphological studies are conducted by Scanning Electron Microscopy (SEM, Zeiss LEO 1550 FESEM). The concentration of metal cations in liquid are measured by Inductively coupled plasma-optical emission spectrometry (ICP-OEM, Spectro Analytical Instruments).

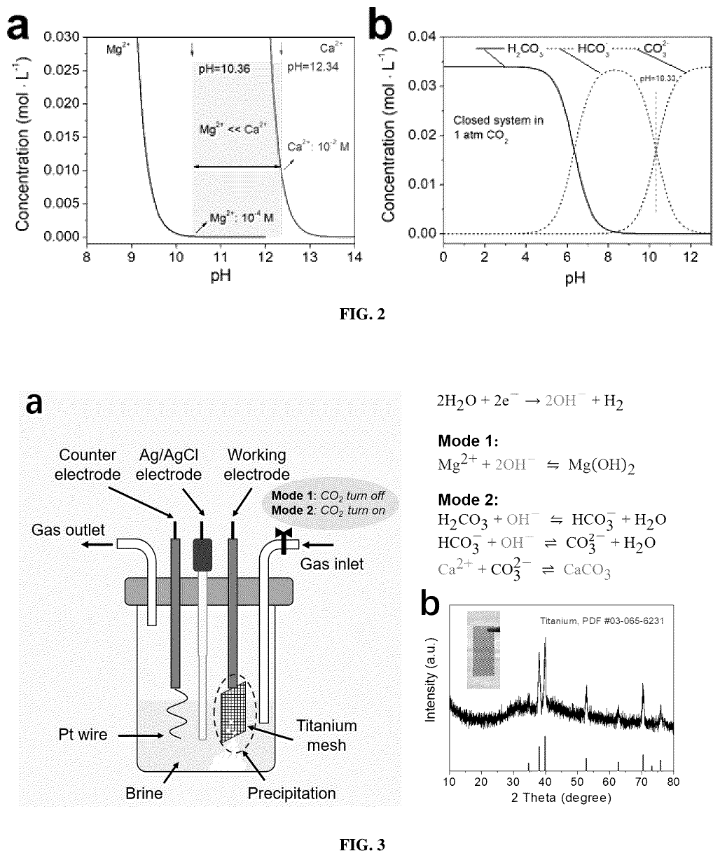

Thermodynamics of dissolution and precipitation: In water solution, the dependence of Ca²⁺ and Mg²⁺ concentrations with pH is shown in FIG. 2, part a, constructed on the basis of Kₛₚ of Mg(OH)₂ and Ca(OH)₂ (Eqs. 2 & 3; see Table I, supra). It is verified that these two types of cations, which are the most abundant in brine and often industrial waters, are able to be separated by simply harnessing pH. When pH situates within the range of 10.36-12.34, the concentration of Mg²⁺ drops to 10⁻⁴ M, while Ca²⁺ is much higher than 10⁻² M, demonstrating that it is technically feasible to separate these two types of divalent cations by simply harnessing pH. The thermodynamic driving force for precipitation is given by the saturation ratio (Ω), where Ω equals the ratio of ion activity product (IAP) to Kₛₚ (Ω=IAP/Kₛₚ). For example, the IAP of brucite is calculated by the product of the activities of [Mg²⁺] and [OH⁻] squared in solution. Precipitation starts when Ω reaches the critical point.

In aqueous solution, both HCO₃⁻ and CO₃²⁻ form through the speciation of CO₂ in water, existing at an equilibrium. The speciation reactions and dissociation constants that describe the CO₂—H₂O system are written as Eqs. 4-6 in Table I, supra, where H₂CO₃* represents the total CO₂ (aq) and H₂CO₃. The dissociation of aqueous CO₂ is visualized by a Bjerrum diagram. As seen in FIG. 2, part b, the activity of CO₃²⁻ anion depends on pH in a closed system. The calculations are based on an ambient atmosphere with CO₂ pressure of 1 atm. In neutral condition (pH=7), the proportion of carbonate is about 1% of all dissolved carbon, while roughly 84% of carbon exists as bicarbonate. However, carbonate ions become dominant when pH rises to 10.33. Thus, the rise of pH favors carbon mineralization as a result of accelerated carbonate formation.

### Results and Discussions

Electrochemical CO₂ mineralization, as well as selective magnesium and calcium recovery, occurs in a single-chamber device (FIG. 3, part a) with a 3-electrode system. Industrial titanium mesh (FIG. 3, part b, inset) is employed as working electrode due to its outstanding activity and stability against acid or alkali. A constant potential of −2.5 V is applied throughout the overall electrochemical experiments. In general, hydroxyl (OH⁻) is continuously produced around the cathode as hydrogen evolution reaction (HER) occurs under a negative potential (Eq. 1). The production of OH leads to local pH increase that prompts selective Mg²⁺ and Ca²⁺ precipitation depending on the pH range as described in FIG. 2, part a. More specifically, the recovery process proceeds in two modes (here, process (b) followed by process (a)), that happen in the same cell under similar conditions.

The exclusive recovery of Mg cations can be achieved by bulk electrolysis. During the first stage of electrolysis (here, process (b)), the produced hydroxyl from water splitting reacts with Mg²⁺, and it leads to the formation of Mg(OH)₂. Since this reaction has lower Kₛₚ (Eq. 2) than the formation of Ca(OH)₂, Mg(OH)₂ is thermodynamically favorable to exclusively precipitate without any other solid compounds. At the end of process (b), Mg(OH)₂ can be easily removed from solution by filter or centrifugation.

Following process (b), the aqueous solution/brine is now Mg-depleted. The Mg-free brine/electrolyte collected after process (b) treatment is an ideal resource for CO₂ mineralization. After the removal of Mg²⁺ (process (b)), Ca²⁺ becomes the dominating divalent cations in the aqueous solution/brine. The subsequent process (a), in which CO₂ is constantly bubbled into the region near to cathode, favors the dissolution of CO₂ due to the elevated pH. Dissolved CO₂ is then partially hydrated and ionized into H⁺ and HCO₃⁻ (Eqs. 4 & 5). The continuous generation of OH due to applied potential ensures further dissolution of CO₂, while it is also consuming H⁺ via neutralization reaction (H⁺+OH⁻→H₂O). As a result, the equilibrium shown in Eqs 4-6 is shifted to favor the generation of carbonate ions (FIG. 2, part b). The existence of Ca²⁺ enables the carbonation, as Ca²⁺ combines with carbonate ions and is removed from the aqueous phase in the form of CaCO₃ precipitate. This product is almost insoluble under alkaline conditions (Eq. 7), and it is easy to separate from the solution. Following process (a), nearly pure CaCO₃ (>96%) can be obtained. As such, Mg²⁺ and Ca²⁺ are separately recovered from brine via a simple, two-mode electrolysis. It is worth noting that both these two modes (i.e., process (b) and process (a)), operate under similar conditions, and they can be simply switched by turning on CO₂ flow.

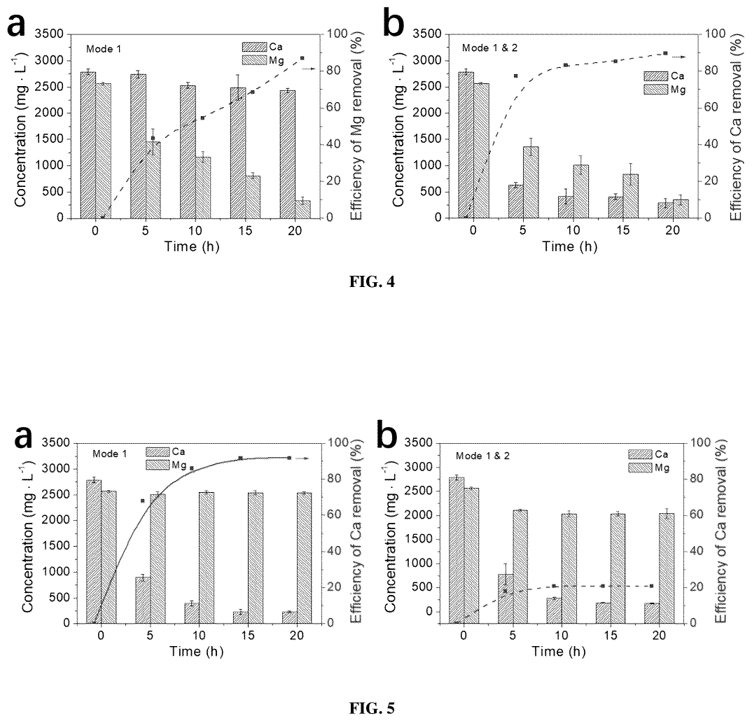

The liquid phases obtained before and after process (b) and process (a) electrolysis were measured by Inductively Coupled Plasma-Optical Emission Spectrometry (ICP-OEM). In process (b), it is observed that the concentration of Mg²⁺ ion in solution dropped significantly from a starting concentration of 2566 ppm to 335 ppm with a removal efficiency of 87% after 20 hours (FIG. 4, part a). In particular, the concentration of Mg²⁺ ion in solution plunged by 43% during the first 5-hour operation, while the Ca²⁺ concentration almost remained unchanged (˜1%), demonstrating high selectivity of Mg precipitation. On the contrary, Ca²⁺ starts to precipitate when CO₂ supply was turned on. In process (a), additional 20-hour electrolysis, the concentration of Ca²⁺ in solution was found to have reduced by 90% (FIG. 4, part b).

Impressively, more than 77% of this reduction was observed within the first 5-hour electrolysis in process (a). In summary, after 20-hour electrolysis of each process, Mg²⁺ and Ca²⁺ are selectively removed from brine via precipitation with efficiencies as high as 87% and 90%, respectively.

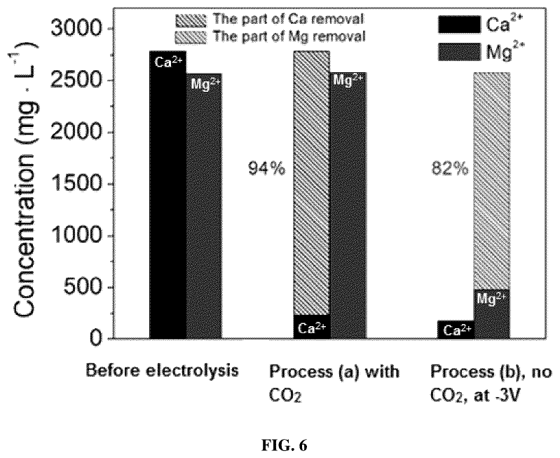

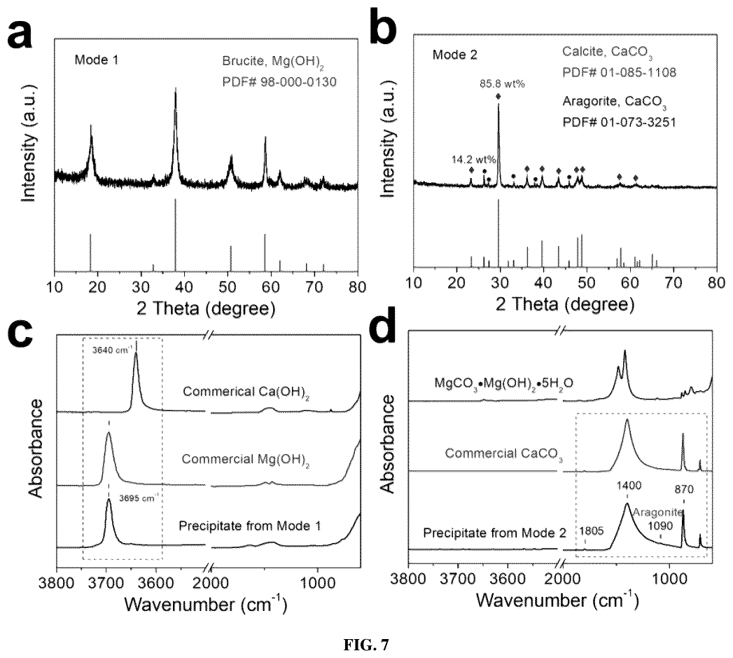

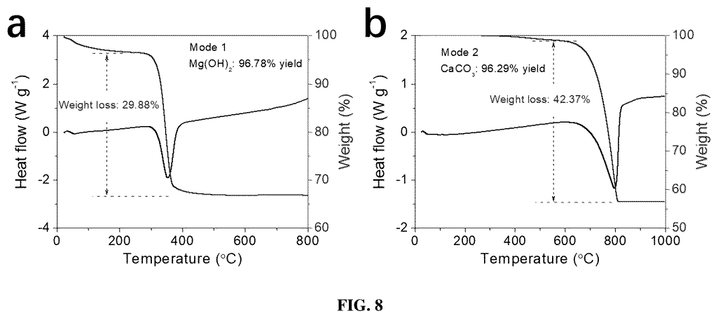

The reversed mode sequence of Mg²⁺ and Ca²⁺ recovery was also studied, removing Ca²⁺ ahead of Mg²⁺ (i.e., process (a) preceding process (b)). As shown in FIG. 5. Ca²⁺ sharply dropped by 94% in the presence of CO₂, while Mg remained the same concentration as original even after 20-hour electrolysis. Despite traces of Ca²⁺ removed from liquid phase at the last 5-hour electrolysis in process (a), Mg²⁺ concentration remained unchanged, indicating that Ca²⁺ can be separated without any concern about Mg²⁺ precipitation. However, in the subsequently-performed process (b). Mg removal efficiency was less than 20% at the same potential (−2.5V) (FIG. 5, part b). This is caused by lower concentration of OH ion after the process (a) electrolysis with CO₂, resulting in a significant drop of the solution's pH. Also, the competing reaction which consumes OH becomes dominating in the situation (4OH⁻-4e⁻→O₂+2H₂O)), resulting in slow precipitation. As such, a greater applied potential is preferred for further Mg²⁺ precipitation. As shown in FIG. 6, when the applied potential increased to the −3 V in the second stage of electrolysis (process (b)), the removal efficiency of Mg²⁺ reached 82%, a nearly 62-percentage-point increase over that of −2.5 V. The results indicates that the recovery efficiencies are significantly dependent on the sequence of removal. Thus, some inventive embodiments selectively remove Mg²⁺ as Mg(OH)₂, followed by Ca²⁺ electrochemical mineralization (i.e., perform process (b) prior to process (a)), as this results in relatively better efficiencies under the same applied potential.

The solid precipitates collected after each process were further investigated by X-ray diffraction (XRD) analysis which can identify the crystalline species of these solid products. As shown in FIG. 7 part a, the XRD pattern of the product collected from Mode 1 (process (b)) matches well with Brucite (PDF #98-000-0130), and no other Bragg peak can be observed. It indicates that brucite crystalline species is exclusively generated in the Mode 1 (process (b). Solid product obtained from Mode 2 (process (a)) shows a group of well-defined CaCO₃ Bragg peaks which can be identified in the XRD pattern (FIG. 7, part b); however, they are attributed to two different CaCO₃ crystalline polymorphs. The major polymorph observed (85.8 wt %) was identified as calcite (PDF #01-085-1108) which is regarded as the most stable crystalline form of CaCO₃, while the rest of these Bragg peaks (14.2 wt %) can be ascribed to aragonite (PDF #01-073-3251). The ratio of generated calcite to aragonite was calculated to be 6:1. These results are also confirmed by Fourier-transform infrared (FTIR) spectra. As shown FIG. 7, parte, the FTIR spectrum of the precipitate from Mode 1 (here, process (b)) demonstrates the existence of hydroxyl, and the peak (3695 cm⁻¹) is located in the exact same position as commercial Mg(OH)₂. This agrees with results obtained from XRD. Meanwhile, a typical set of vibrations of the carbonate (1805, 1400, 1090 and 870 cm⁻¹) can be observed (FIG. 7, part d) in solid product obtained from Mode 2 (here, process (a)). Note that the peak in 1090 cm⁻¹ is attributed to aragonite. No other peak was found, indicating the exclusive formation of CaCO₃ which is also consistent with XRD consequences. Therefore, Mg and Ca are separately removed from brine via the electrochemical formation of Mg(OH)₂ and CaCO₃, respectively. Simultaneously. CO₂ is mineralized into calcite and aragonite which can be further utilized.

Further evidence of selective Mg(OH)₂ and CaCO₃ formation in process (b) and process (a) respectively was found using thermogravimetric analysis (TGA). For the solid product obtained from Mode 1 (process (b)) (FIG. 8, part a), obvious weight loss was observed as the temperature rises above 255° C., and ended at 415° C. This temperature range of weight loss is analogous to commercial Mg(OH)₂, implying the existence of similar substance. This weight loss is caused by the decomposition of Mg(OH)₂ into MgO and H₂O which typically occurs within that temperature range, and in complete agreement with XRD results (not shown). Since there is only a weight loss peak observed, it can be fully attributed to the evaporation of H₂O after decomposition. The purity of Mg(OH)₂ is calculated to be as high as 96.78 wt %. For the solid product obtained from Mode 2 (process (a)), obvious weight loss was observed within the temperature range of 553-808° C. (FIG. 8, part b). This weight loss can be ascribed to the decomposition of CaCO₃ into CaO and CO₂. Similarly, the content of CaCO₃ is evaluated to be 96.29% on the basis of 42.37 wt % CO₂ evolved during CaCO₃ decomposition.

Mg(OH)₂_{₍ₛ₎}→MgO₍ₛ₎+H₂O_{(g)} 200-500° C. (9)

CaCO₃_{₍ₛ₎}→CaO₍ₛ₎+CO₂_{_{(g)}} 600-800° C. (10)

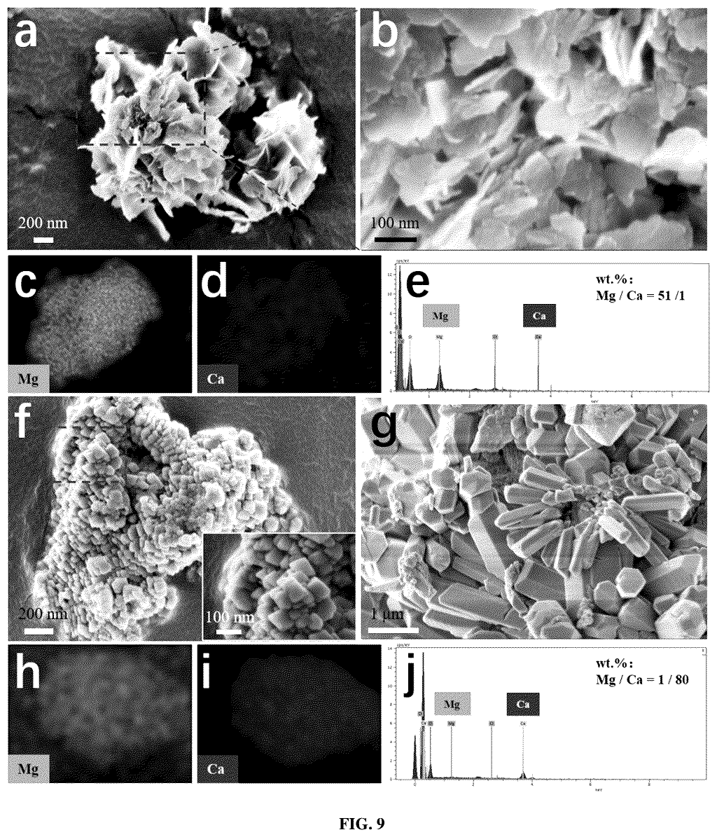

Scanning electron microscopy (SEM) images (FIG. 9, part a) of the solid product obtained from mode 1 (process (b)) show the presence of flake-like morphologies typically found in brucite, and it is clearly visualized in the magnified image (FIG. 9, part b). Also, energy dispersive X-ray spectroscopy (EDS) mappings shows a strong signal of Mg (FIG. 9, part c) and negligible noise from Ca (FIG. 9, part d). The EDS spectrum indicates that Mg is the dominant alkaline metal present in the particle, and the weight ratio of Mg and Ca was calculated to be 51:1 (FIG. 9, part e). It is worth noting that the generated powder exhibits a considerably large surface area. 144.33 m² g⁻¹, which is more than 10 times greater than that of the commercial brucite used for comparison in this study. This is beneficial for further utilization of the precipitate. For example, in CO₂ capture applications, Mg(OH)₂ particles with larger surface area have been found to have better kinetics. Meanwhile, deformed cube calcite (FIG. 9, part f) and needle-like aragonite (FIG. 9, part g) morphologies was seen in the solid product obtained from Mode 2 (process (a)). This is also consistent with the XRD and FTIR results (FIG. 9, part b). Further, EDS mappings show the even dispersion of Ca (FIG. 9, part i) over a selected particle, with a weight ratio of 80:1 for Ca:Mg (FIG. 9, part j). In summary, all results verify the selective recovery of Mg and Ca from brine. It is worth noting that CO₂ mineralization happens simultaneously with Mode 2 (process (a)).

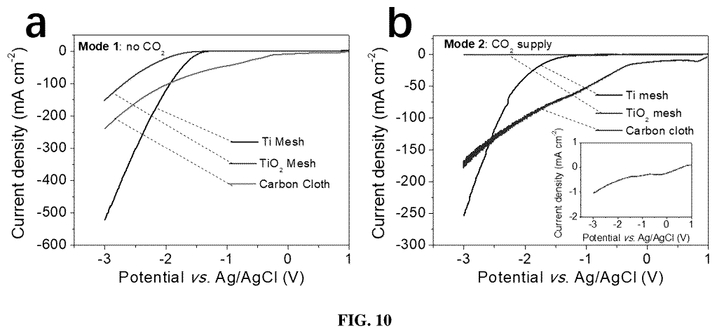

Electrode stability and activity are key considerations in the design of the system. In this embodiment, an industrial titanium mesh is employed as working electrode for long-term electrolysis, and it is tested to be the most active material for carbon mineralization. As shown in FIG. 10 part a, the measured linear sweep voltammetry (LSV) curve of Ti mesh electrode in the CO₂-free electrolyte (Mode 1, process (b)) shows that the onset potential is close to −1.5 V, giving a current density of −300 mA cm⁻² at −2.5 V. In contrast to Ti mesh, the control electrodes involving TiO₂ mesh and carbon cloth exhibit much lower current density, suggesting the superior activity of Ti mesh. Similar results can be seen in the CO₂-saturated electrolyte (FIG. 10, part b). It was also observed that all current densities decline when compared with those values obtained in the CO₂-free electrolyte. This decline is caused by a pH drop associated with the addition of CO₂ which leads to a more acidic solution. According to the equation, E (vs. RHE)=E (vs. Ag/AgCl)+0.197 V+0.059×pH, the potentials (vs. RHE) decrease with pH decline, and this results in a lower applied potential observed in the Mode 2 (process (a)).

Furthermore, the Ti mesh electrode was identified to be corrosion-resistant for long-term electrolysis even with the existence of chlorine anions. Although the equilibrium potential of oxygen evolution reaction (OER, Eq. 9) is more negative than that of chlorine evolution reaction (CIER, Eq. 10) by 130 mV, CIER is kinetically favorable. OER is a 4-electron oxidation, while CIER is a facile two-electron oxidation requiring a lower overpotential. Therefore, CIER has much faster kinetics and is the dominant anodic reaction. Note that chlorine electro-oxidation reaction (CIOR, Eq. 11) usually occurs around anode during electrolysis, which also compete with OER. As a result, the suppression of OH consumption due to more favorable CIER and CIOR reactions leads to preferential formation of brucite and subsequent carbon mineralization in the 2-mode electrolysis. Under alkaline conditions (pH=8.42, Mode 1, process (b)), the aggressive chlorine anions can corrode electrodes through metal chloride-hydroxide formation mechanism. With carbon cloth, a gradual decay with electrolysis for splitting seawater can be observed (not shown). However, a piece of Ti mesh can be reused for many times without obvious decay, indicating its extraordinary corrosion resistance and potential application in industry.

4OH⁻_{(aq)}-4e⁻→O₂_{_{(g)}}+2H₂O E⁰=1.23 V (vs. SHE) (9)^{[24]}

2Cl⁻_{(aq)}-e⁻→Cl₂_{_{(g)}} E⁰=1.36 V (vs. SHE) (10)^{[24]}

2Cl⁻_{(aq)}+2OH⁻_{(aq)}-e⁻→2CIO⁻_{(aq)}+H₂O E⁰=1.72 V (vs. SHE) (11)^{[25]}

### CONCLUSION

In summary, the testing described above demonstrates a two mode electrochemical carbon mineralization process that harnesses Ca- and Mg-rich aqueous solutions, and selectively extracts Ca and Mg as CaCO₃ and Mg(OH)₂, respectively. Magnesium hydroxide and calcium carbonate with purities as high as 96.78% and 96.29% respectively was obtained after 2-mode electrolysis (process (b) followed by process (a)). This technology has the potential to utilize vast amounts of Mg²⁺ and Ca²⁺ in brine to produce value added materials while simultaneously serving as a CO₂ sink. Further, the forgoing embodiment utilizes industrial titanium mesh, which has been widely reported to be scalable as working electrodes. Further, stability tests showed impressive corrosion-resistant properties even in chlorine-containing systems, which implies reusability over multiple cycle without obvious decay.

Selective removal of Mg²⁺ and Ca²⁺ via precipitation with efficiencies as high as 87% and 90% respectively was reached, which has a potential to considerably reduce the salinity of brine, facilitating a more material efficient disposal while also significantly reducing the environmental risks to the aquatic ecosystem.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a composition or article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Embodiments of the inventive method are distinguished from the disclosures within the references discussed herein, including over Carré et al., Environmental Chemistry Letters (2020) 18:1193-1208, Rau, Environ. Sci. Technol. 2008, 42, 8935-8940, and Xie et al., Environ Earth Sci (2015) 73:6881-6890.

Where one or more ranges are referred to throughout this specification, each range is intended to be a shorthand format for presenting information, where the range is understood to encompass each discrete point within the range, and further to encompass any subrange within the range between any discrete point within the range and any other discrete point within the range, as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

1. A method for recovering calcium carbonate (CaCO₃) and magnesium hydroxide (Mg(OH)₂) from an aqueous solution comprising calcium (Ca²⁺) and magnesium (Mg²⁺) ions, said method comprising:
introducing the aqueous solution into an electrochemical cell comprising a chamber that houses a photoactive cathode and an anode, wherein the cathode and anode are not separated by a membrane; and then
performing process (a):
introducing a gaseous source of (bi) carbonate anion into the cell;
providing a voltage across the cell, thereby resulting in a process (a) water reduction reaction at the cathode; and
precipitating solid CaCO₃ from the solution, facilitated by hydroxide ions generated from the process (a) water reduction reaction;
and, separate from performing process (a), in the same chamber, performing process (b):
providing a voltage across the cell, thereby resulting in a process (b) water reduction reaction at the cathode; and
precipitating solid Mg(OH)₂ from the solution, facilitated by hydroxide ions generated from the process (b) water reduction reaction.

2. The method according to claim 1, wherein the aqueous solution comprises sea water or process water from an industrial process.

3. The method according to claim 1, wherein process (a) is performed before process (b).

4. The method according to claim 1, wherein process (b) is performed before process (a).

5. The method according to claim 1, wherein, for process (a) and/or process (b):
the concentration of Ca²⁺ ions in the aqueous solution is from 100 mg/L to 1500 mg/L; and/or
the concentration of Mg²⁺ ions is from 100 mg/L to 1500 mg/L.

6. The method according to claim 1, wherein, for process (a) and/or process (b):
the concentration of Ca²⁺ ions in the aqueous solution is greater than or equal to 300 mg/L; and/or
the concentration of Mg²⁺ ions in the aqueous solution is greater than or equal to 300 mg/L Mg²⁺ ions,
wherein the aqueous solution has a Ca²⁺ ion concentration and/or a Mg²⁺ ion concentration such that solubility limits for producing solid carbonate and/or solid hydroxide are not reached under ambient conditions.

7. The method according to claim 1, wherein, for process (a) and/or process (b), the aqueous solution has a Ca²⁺ ion concentration and/or a Mg²⁺ ion concentration such that solubility limits for producing solid carbonate and/or solid hydroxide are not reached under ambient conditions.

8. (canceled)

9. The method according to claim 18, wherein the source of (bi) carbonate anion is gaseous CO₂.

10. (canceled)

11. The method according to claim 1, comprising, while performing process (a) and/or process (b), providing a voltage that results in water oxidation which is within the range of −3.5 V to −2.0 V across the cell.

12. The method according to claim 1, comprising performing process (a), thereby yielding a precipitated reaction product comprising the solid CaCO₃, wherein the precipitated reaction product from process (a):
comprises greater than or equal to 80 wt % CaCO₃; and/or
comprises less than or equal to 10 wt % Mg(OH)₂; and/or
is characterized by an infrared (IR) spectrum that does not show a peak corresponding to Mg(OH)₂.

13. The method according to claim 1, comprising performing process (a), thereby precipitating the solid CaCO₃, wherein at least 80 wt % of the solid CaCO₃ is calcite.

14. (canceled)

15. The method according to claim 1, comprising performing process (b), thereby yielding a precipitated reaction product comprising the solid Mg(OH)₂, wherein the precipitated reaction product from process (b):
comprises greater than or equal to 80 wt % Mg(OH)₂; and/or
comprises less than or equal to 10 wt % CaCO₃; and/or
is characterized by an infrared (IR) spectrum that does not show a peak corresponding to CaCO₃.

16. The method according to claim 1, wherein the cathode comprises titanium, carbon, copper, steel, nickel, platinum, palladium, iron, iridium, molybdenum, cobalt, gold, or silver cathode, wherein the cathode further comprises an oxide coating (e.g., a metal oxide coating).

17. (canceled)

18. The method according to claim 1, wherein the cathode comprises a texturized surface, wherein the texturized surface is a mesh surface (e.g., titanium mesh), a porous surface, an etched surface, or a surface comprising nanostructures.

19. (canceled)

20. The method according to claim 1, wherein the anode comprises carbon (e.g., graphite), nickel, platinum, palladium, iron, iridium, molybdenum, cobalt, gold, or silver.

21. The method according to claim 1, wherein the source of (bi) carbonate anion comes directly from air and/or point source emissions and/or post combustion CO₂ capture (e.g., flue gas), wherein the source of (bi) carbonate anion has a CO₂ concentration in the range of 400 ppm of CO₂ in a gas to 100 vol % CO₂.

22. (canceled)

23. The method according to claim 1, wherein said method does not comprise introducing alkaline material into the aqueous solution.

24. The method according to claim 1, further comprising, in a single step, collecting from the chamber both solid CaCO₃ precipitate and solid Mg(OH)₂ precipitate.

25. The method according to claim 1, comprising stirring (e.g., via use of stirring elements) contents of the chamber while performing process (a) and/or while performing process (b).

26. The method according to claim 1, wherein:
during process (a), said providing a voltage across the cell comprises pulsing the voltage by switching between higher and lower voltages; and/or
during process (b), said providing a voltage across the cell comprises pulsing the voltage by switching between higher and lower voltages.
